(19) United States
(12) Patent Application Publication
(10) Pub. No.: US 2017/0279831 A1
(43) Pub. Date: Sep. 28, 2017

(54) USE OF URL REPUTATION SCORES IN DISTRIBUTED BEHAVIORAL ANALYTICS SYSTEMS

(71) Applicant: Cisco Technology, Inc., San Jose, CA (US)

(72) Inventors: Andrea Di Pietro, Lausanne (CH); Jean-Philippe Vasseur, Anchorage, AK (US); Sukrit Dasgupta, Norwood, MA (US)

(21) Appl. No.: 15/182,190

(22) Filed: Jun. 14, 2016

Related U.S. Application Data
(60) Provisional application No. 62/313,166, filed on Mar. 25, 2016.

(51) Int. Cl. H04L 29/06; H04L 12/26; H04L 29/08

(52) U.S. Cl. CPC H04L 63/1425; H04L 67/146; H04L 67/02; H04L 43/0894; H04L 43/062

(57) ABSTRACT

In one embodiment, a device in a network identifies a universal resource locator (URL) from traffic destined for the URL that triggered a first anomaly detected by an anomaly detector. The device reports the first anomaly and the identified URL to a supervisory device in the network. The device receives a URL filter rule for the URL. The URL filter rule is configured to affect anomaly scores generated by the anomaly detector for traffic destined for the URL or a domain associated with the URL. The device uses the URL filter rule to adjust an anomaly score for a second anomaly detected by the anomaly detector based on the second anomaly involving traffic destined for the URL or the domain associated with the URL.

### RELATED APPLICATIONS

This application claims priority to U.S. Provisional Application No. 62/313,166, filed Mar. 25, 2016, entitled “USE OF URL REPUTATION SCORES IN DISTRIBUTED BEHAVIORAL ANALYTICS SYSTEMS,” by Di Pietro et al., the contents of which are hereby incorporated by reference.

### TECHNICAL FIELD

The present disclosure relates generally to computer networks, and, more particularly, to using universal resource locator (URL) reputation scores in distributed behavioral analytics systems.

### BACKGROUND

Enterprise networks are carrying a very fast growing volume of both business and non-business critical traffic. Often, business applications such as video collaboration, cloud applications, etc., use the same Hypertext Transfer Protocol (HTTP) and/or HTTP secure (HTTPS) techniques that are used by non-business critical web traffic.

Generally, Internet Behavioral Analytics (IBA) refers to the use of advanced analytics coupled with various networking technologies, to detect anomalies in a network. Such anomalies may include, for example, network attacks, malware, misbehaving and misconfigured devices, and the like. For example, the ability to model the behavior of a device (e.g., a host, networking switch, router, etc.) allows for the detection of malware, which is complimentary to the use of firewalls that use static signature. Observing behavioral changes (e.g., deviation from modeled behavior) using flows records, deep packet inspection, and the like, allows for the detection of an anomaly such as a horizontal movement (e.g. propagation of a malware, . . . ) or an attempt to perform information exfiltration, prompting the system to take remediation actions automatically.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example self learning network (SLN) infrastructure;

FIG. 4 illustrates an example distributed learning agent (DLA);

FIG. 5 illustrates an example plot of URL lengths;

FIG. 6 illustrates an example architecture for using URL reputation scores in an SLN;

FIGS. 7A-7D illustrate examples of a DLA using a URL filter based on a reputation score;

FIG. 8 illustrates an example simplified procedure for using a URL filter rule; and

FIG. 9 illustrates an example simplified procedure for generating and sending a URL filter rule.

### DESCRIPTION OF EXAMPLE EMBODIMENTS

### Overview

According to one or more embodiments of the disclosure, a device in a network identifies a universal resource locator (URL) from traffic destined for the URL that triggered a first anomaly detected by an anomaly detector. The device reports the first anomaly and the identified URL to a supervisory device in the network. The device receives a URL filter rule for the URL. The URL filter rule is configured to affect anomaly scores generated by the anomaly detector for traffic destined for the URL or a domain associated with the URL. The device uses the URL filter rule to adjust an anomaly score for a second anomaly detected by the anomaly detector based on the second anomaly involving traffic destined for the URL or the domain associated with the URL.

In further embodiments, a supervisory device in a network receives an anomaly report that indicates that another device in the network detected anomalous traffic. The anomaly report comprises a universal resource locator (URL) to which the anomaly traffic was destined. The supervisory device determines a measure of suspiciousness of the URL using a reputation database. The supervisory device generates a URL filter rule based on the measure of suspiciousness. The URL filter rule is configured to affect anomaly scores generated by an anomaly detector for traffic destined for the URL or a domain associated with the URL. The supervisory device sends the URL filter rule to the device that detected the anomalous traffic. The device that detected the anomalous traffic adjusts an anomaly score for a subsequent anomaly using the URL filter rule.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

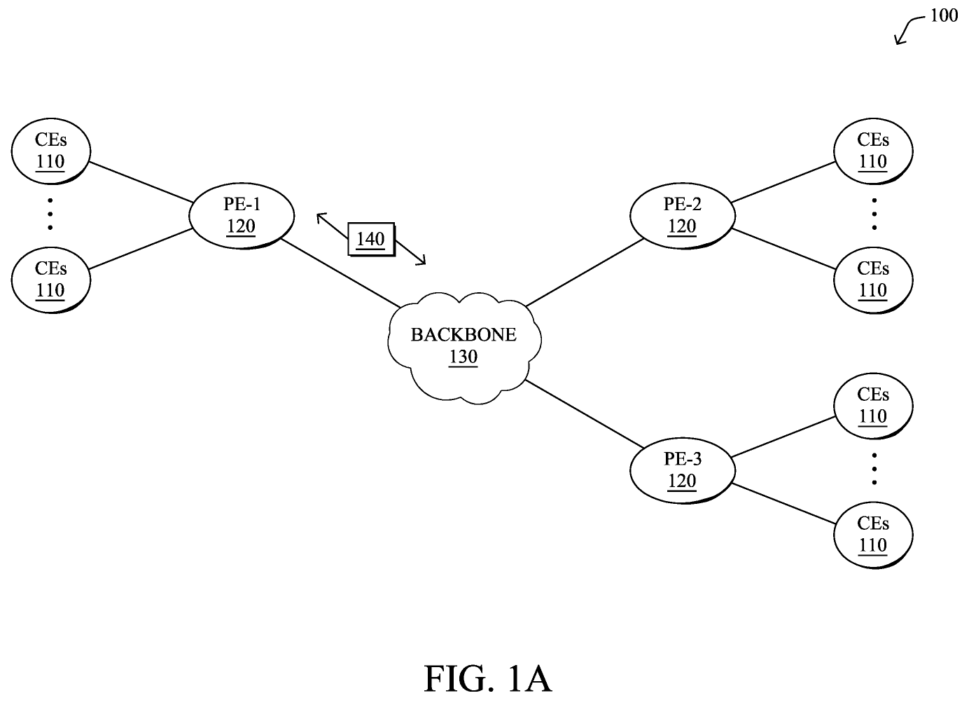

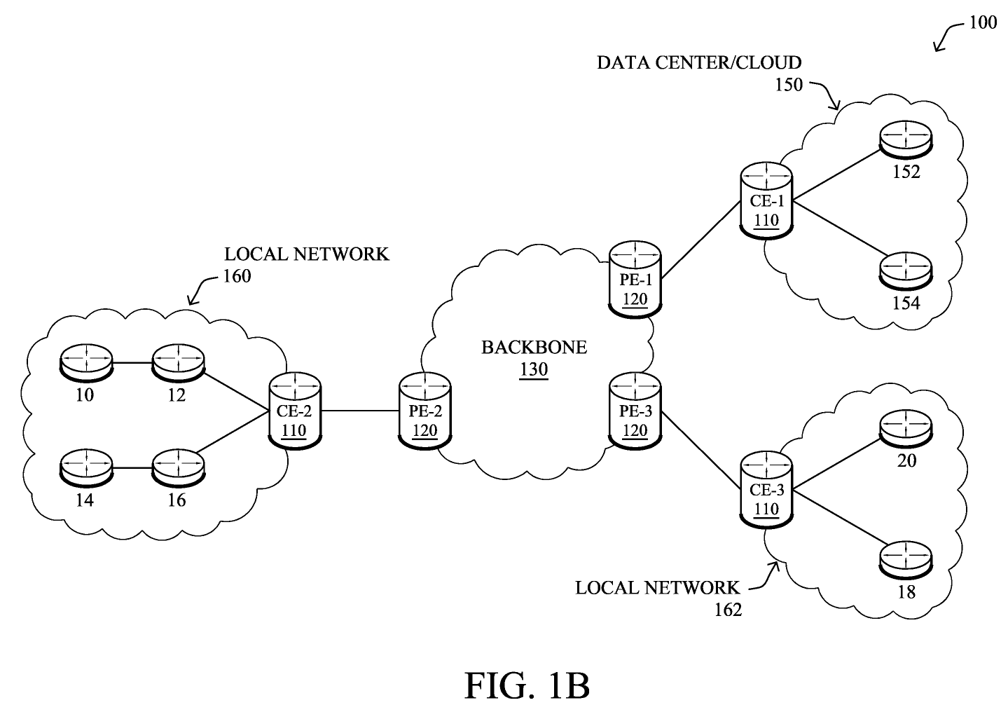

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

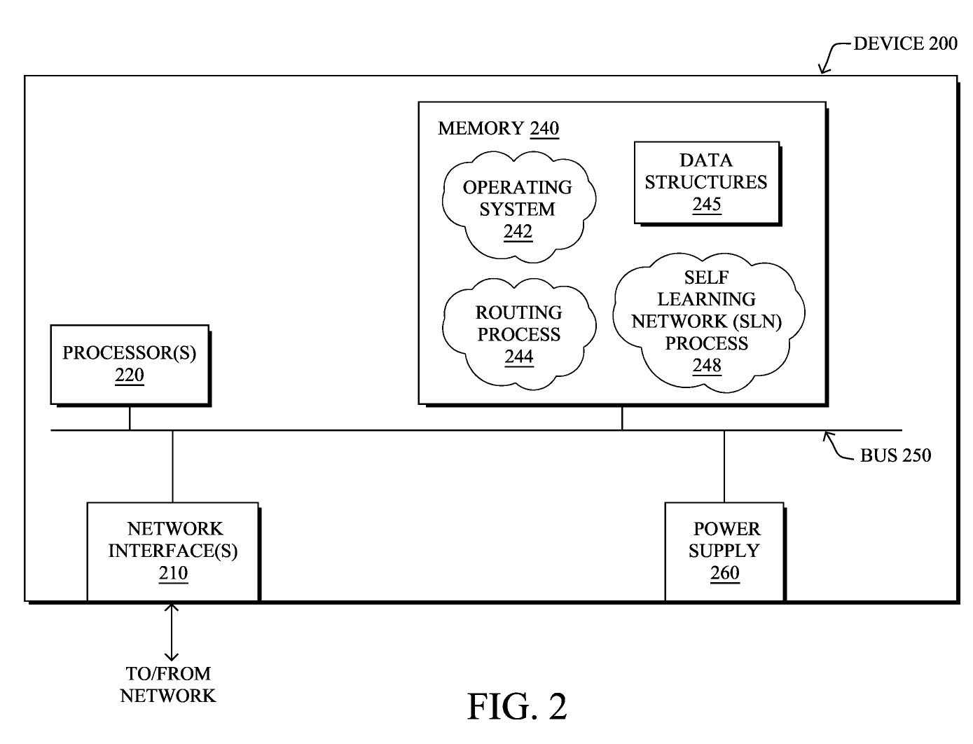

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise routing process 244 (e.g., routing services) and illustratively, a self learning network (SLN) process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process/services 244 include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instance, or tunneling protocols, such as for MPLS, generalized MPLS (GMPLS), etc., each as will be understood by those skilled in the art. Also, EVPN, e.g., as described in the IETF Internet Draft entitled “BGP MPLS Based Ethernet VPN”<draft-ietf-12vpn-evpn>, introduce a solution for multipoint L2VPN services, with advanced multi-homing capabilities, using BGP for distributing customer/client media access control (MAC) address reach-ability information over the core MPLS/IP network.

SLN process 248 includes computer executable instructions that, when executed by processor(s) 220, cause device 200 to perform anomaly detection functions as part of an anomaly detection infrastructure within the network. In general, anomaly detection attempts to identify patterns that do not conform to an expected behavior. For example, in one embodiment, the anomaly detection infrastructure of the network may be operable to detect network attacks (e.g., DDoS attacks, the use of malware such as viruses, rootkits, etc.). However, anomaly detection in the context of computer networking typically presents a number of challenges: 1.) a lack of a ground truth (e.g., examples of normal vs. abnormal network behavior), 2.) being able to define a “normal” region in a highly dimensional space can be challenging, 3.) the dynamic nature of the problem due to changing network behaviors/anomalies, 4.) malicious behaviors such as malware, viruses, rootkits, etc. may adapt in order to appear “normal,” and 5.) differentiating between noise and relevant anomalies is not necessarily possible from a statistical standpoint, but typically also requires domain knowledge.

Anomalies may also take a number of forms in a computer network: 1.) point anomalies (e.g., a specific data point is abnormal compared to other data points), 2.) contextual anomalies (e.g., a data point is abnormal in a specific context but not when taken individually), or 3.) collective anomalies (e.g., a collection of data points is abnormal with regards to an entire set of data points). Generally, anomaly detection refers to the ability to detect an anomaly that could be triggered by the presence of malware attempting to access data (e.g., data exfiltration), spyware, ransom-ware, etc. and/or non-malicious anomalies such as misconfigurations or misbehaving code. Particularly, an anomaly may be raised in a number of circumstances:
Security threats: the presence of a malware using unknown attacks patterns (e.g., no static signatures) may lead to modifying the behavior of a host in terms of traffic patterns, graphs structure, etc. Machine learning processes may detect these types of anomalies using advanced approaches capable of modeling subtle changes or correlation between changes (e.g., unexpected behavior) in a highly dimensional space. Such anomalies are raised in order to detect, e.g., the presence of a 0-day malware, malware used to perform data ex-filtration thanks to a Command and Control (C2) channel, or even to trigger (Distributed) Denial of Service (DoS) such as DNS reflection, UDP flood, HTTP recursive get, etc. In the case of a (D)DoS, although technical an anomaly, the term “DoS” is usually used. SLN process 248 may detect malware based on the corresponding impact on traffic, host models, graph-based analysis, etc., when the malware attempts to connect to a C2 channel, attempts to move laterally, or exfiltrate information using various techniques.
Misbehaving devices: a device such as a laptop, a server of a network device (e.g., storage, router, switch, printer, etc.) may misbehave in a network for a number of reasons: 1.) a user using a discovery tool that performs (massive) undesirable scanning in the network (in contrast with a lawful scanning by a network management tool performing device discovery), 2.) a software defect (e.g. a switch or router dropping packet because of a corrupted RIB/FIB or the presence of a persistent loop by a routing protocol hitting a corner case).
Dramatic behavior change: the introduction of a new networking or end-device configuration, or even the introduction of a new application may lead to dramatic behavioral changes. Although technically not anomalous, an SLN-enabled node having computed behavioral model(s) may raise an anomaly when detecting a brutal behavior change. Note that in such as case, although an anomaly may be raised, a learning system such as SLN is expected to learn the new behavior and dynamically adapts according to potential user feedback.
Misconfigured devices: a configuration change may trigger an anomaly: a misconfigured access control list (ACL), route redistribution policy, routing policy, QoS policy maps, or the like, may have dramatic consequences such a traffic black-hole, QoS degradation, etc. SLN process 248 may advantageously identify these forms of misconfigurations, in order to be detected and fixed.

In various embodiments, SLN process 248 may utilize machine learning techniques, to perform anomaly detection in the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes of anomaly detection in a network, a learning machine may construct a model of normal network behavior, to detect data points that deviate from this model. For example, a given model (e.g., a supervised, un-supervised, or semi-supervised model) may be used to generate and report anomaly scores to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of anomaly detection is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of anomaly detection. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

According to various embodiments, SLN process 248 may also use graph-based models for purposes of anomaly detection. Generally speaking, a graph-based model attempts to represent the relationships between different entities as a graph of nodes interconnected by edges. For example, ego-centric graphs have been used to represent the relationship between a particular social networking profile and the other profiles connected to it (e.g., the connected “friends” of a user, etc.). The patterns of these connections can then be analyzed for purposes of anomaly detection. For example, in the social networking context, it may be considered anomalous for the connections of a particular profile not to share connections, as well. In other words, a person's social connections are typically also interconnected. If no such interconnections exist, this may be deemed anomalous.

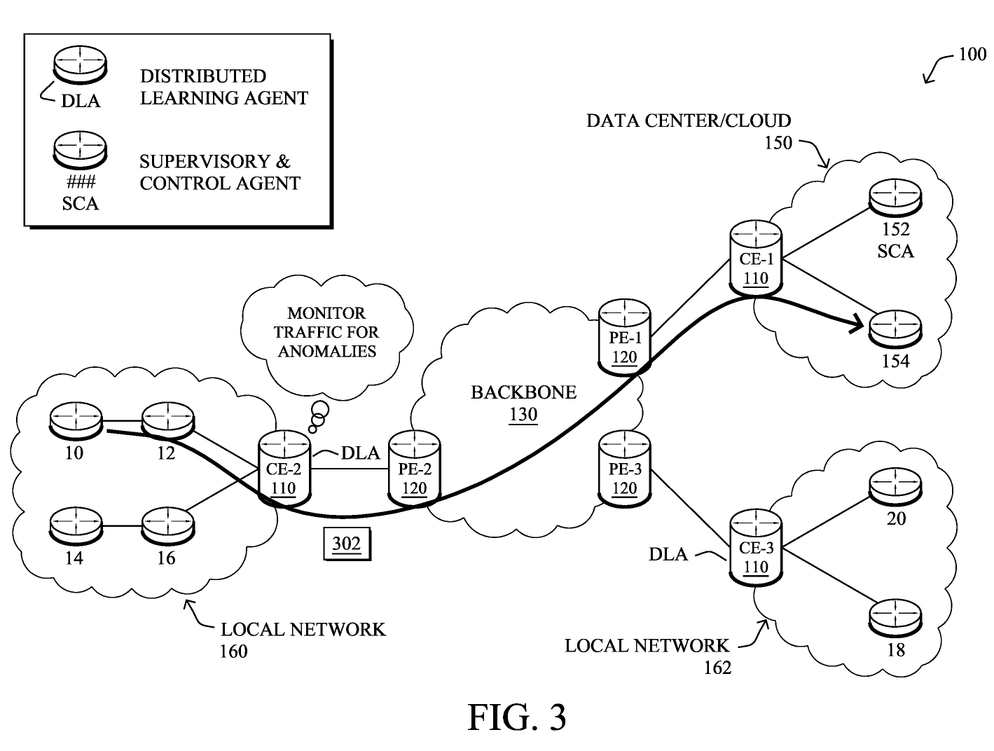

An example self learning network (SLN) infrastructure that may be used to detect network anomalies is shown in FIG. 3, according to various embodiments. Generally, network devices may be configured to operate as part of an SLN infrastructure to detect, analyze, and/or mitigate network anomalies such as network attacks (e.g., by executing SLN process 248). Such an infrastructure may include certain network devices acting as distributed learning agents (DLAs) and one or more supervisory/centralized devices acting as a supervisory and control agent (SCA). A DLA may be operable to monitor network conditions (e.g., router states, traffic flows, etc.), perform anomaly detection on the monitored data using one or more machine learning models, report detected anomalies to the SCA, and/or perform local mitigation actions. Similarly, an SCA may be operable to coordinate the deployment and configuration of the DLAs (e.g., by downloading software upgrades to a DLA, etc.), receive information from the DLAs (e.g., detected anomalies/attacks, compressed data for visualization, etc.), provide information regarding a detected anomaly to a user interface (e.g., by providing a webpage to a display, etc.), and/or analyze data regarding a detected anomaly using more CPU intensive machine learning processes.

One type of network attack that is of particular concern in the context of computer networks is a Denial of Service (DoS) attack. In general, the goal of a DoS attack is to prevent legitimate use of the services available on the network. For example, a DoS jamming attack may artificially introduce interference into the network, thereby causing collisions with legitimate traffic and preventing message decoding. In another example, a DoS attack may attempt to overwhelm the network's resources by flooding the network with requests (e.g., SYN flooding, sending an overwhelming number of requests to an HTTP server, etc.), to prevent legitimate requests from being processed. A DoS attack may also be distributed, to conceal the presence of the attack. For example, a distributed DoS (DDoS) attack may involve multiple attackers sending malicious requests, making it more difficult to distinguish when an attack is underway. When viewed in isolation, a particular one of such a request may not appear to be malicious. However, in the aggregate, the requests may overload a resource, thereby impacting legitimate requests sent to the resource.

Botnets represent one way in which a DDoS attack may be launched against a network. In a botnet, a subset of the network devices may be infected with malicious software, thereby allowing the devices in the botnet to be controlled by a single master. Using this control, the master can then coordinate the attack against a given network resource.

DoS attacks are relatively easy to detect when they are brute-force (e.g. volumetric), but, especially when highly distributed, they may be difficult to distinguish from a flash-crowd (e.g., an overload of the system due to many legitimate users accessing it at the same time). This fact, in conjunction with the increasing complexity of performed attacks, makes the use of “classic” (usually threshold-based) techniques useless for detecting them. However, machine learning techniques may still be able to detect such attacks, before the network or service becomes unavailable. For example, some machine learning approaches may analyze changes in the overall statistical behavior of the network traffic (e.g., the traffic distribution among flow flattens when a DDoS attack based on a number of microflows happens). Other approaches may attempt to statistically characterizing the normal behaviors of network flows or TCP connections, in order to detect significant deviations. Classification approaches try to extract features of network flows and traffic that are characteristic of normal traffic or malicious traffic, constructing from these features a classifier that is able to differentiate between the two classes (normal and malicious).

As shown in FIG. 3, routers CE-2 and CE-3 may be configured as DLAs and server 152 may be configured as an SCA, in one implementation. In such a case, routers CE-2 and CE-3 may monitor traffic flows, router states (e.g., queues, routing tables, etc.), or any other conditions that may be indicative of an anomaly in network 100. As would be appreciated, any number of different types of network devices may be configured as a DLA (e.g., routers, switches, servers, blades, etc.) or as an SCA.

Assume, for purposes of illustration, that CE-2 acts as a DLA that monitors traffic flows associated with the devices of local network 160 (e.g., by comparing the monitored conditions to one or more machine-learning models). For example, assume that device/node 10 sends a particular traffic flow 302 to server 154 (e.g., an application server, etc.). In such a case, router CE-2 may monitor the packets of traffic flow 302 and, based on its local anomaly detection mechanism, determine that traffic flow 302 is anomalous. Anomalous traffic flows may be incoming, outgoing, or internal to a local network serviced by a DLA, in various cases.

In some cases, traffic 302 may be associated with a particular application supported by network 100. Such applications may include, but are not limited to, automation applications, control applications, voice applications, video applications, alert/notification applications (e.g., monitoring applications), communication applications, and the like. For example, traffic 302 may be email traffic, HTTP traffic, traffic associated with an enterprise resource planning (ERP) application, etc.

In various embodiments, the anomaly detection mechanisms in network 100 may use Internet Behavioral Analytics (IBA). In general, IBA refers to the use of advanced analytics coupled with networking technologies, to detect anomalies in the network. Although described later with greater details, the ability to model the behavior of a device (networking switch/router, host, etc.) will allow for the detection of malware, which is complementary to the use of a firewall that uses static signatures. Observing behavioral changes (e.g., a deviation from modeled behavior) thanks to aggregated flows records, deep packet inspection, etc., may allow detection of an anomaly such as an horizontal movement (e.g. propagation of a malware, etc.), or an attempt to perform information exfiltration.

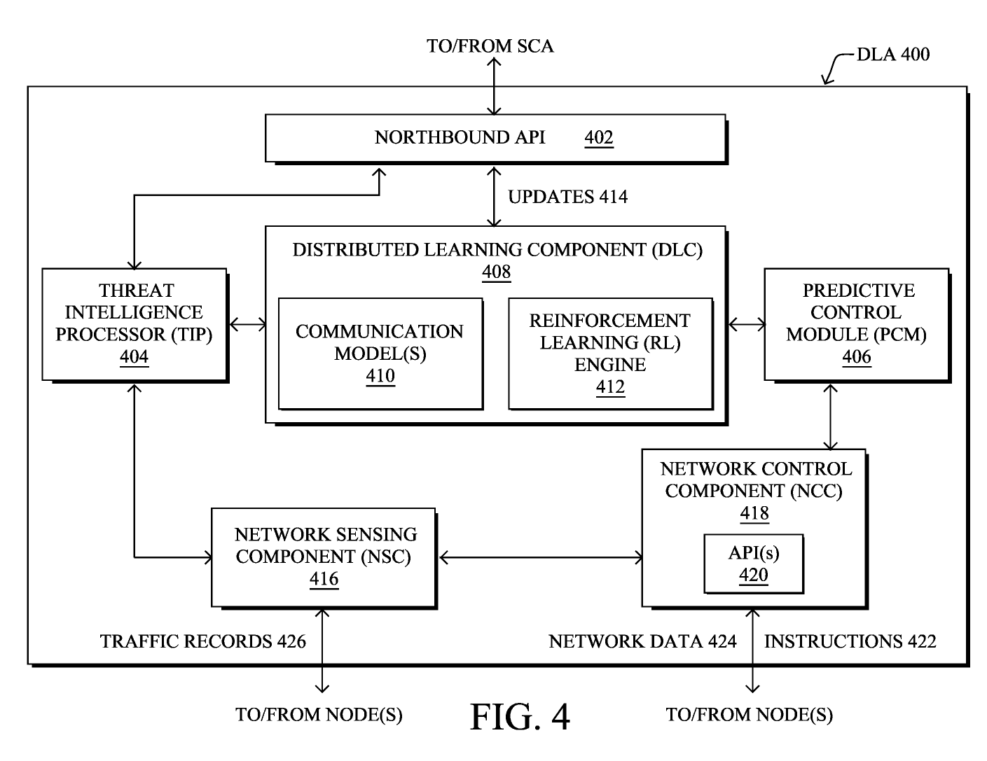

FIG. 4 illustrates an example distributed learning agent (DLA) 400 in greater detail, according to various embodiments. Generally, a DLA may comprise a series of modules hosting sophisticated tasks (e.g., as part of an overall SLN process 248). Generally, DLA 400 may communicate with an SCA (e.g., via one or more northbound APIs 402) and any number of nodes/devices in the portion of the network associated with DLA 400 (e.g., via APIs 420, etc.).

In some embodiments, DLA 400 may execute a Network Sensing Component (NSC) 416 that is a passive sensing construct used to collect a variety of traffic record inputs 426 from monitoring mechanisms deployed to the network nodes. For example, traffic record inputs 426 may include Cisco™ Netflow records or other traffic information, application identification information from a Cisco™ Network Based Application Recognition (NBAR) process or another application-recognition mechanism, administrative information from an administrative reporting tool (ART), local network state information service sets, media metrics, raw packets, or the like.

Furthermore, NSC 416 may be configured to dynamically employ Deep Packet Inspection (DPI), to enrich the mathematical models computed by DLA 400, a critical source of information to detect a number of anomalies. Also of note is that accessing control/data plane data may be of utmost importance, to detect a number of advanced threats such as data exfiltration. NSC 416 may be configured to perform data analysis and data enhancement (e.g., the addition of valuable information to the raw data through correlation of different information sources). Moreover, NSC 416 may compute various networking based metrics for use by the Distributed Learning Component (DLC) 408, such as a large number of statistics, some of which may not be directly interpretable by a human.

In some embodiments, DLA 400 may also include DLC 408 that may perform a number of key operations such as any or all of the following: computation of Self Organizing Learning Topologies (SOLT), computation of “features” (e.g., feature vectors), advanced machine learning processes, etc., which DLA 400 may use in combination to perform a specific set of tasks. In some cases, DLC 408 may include a reinforcement learning (RL) engine 412 that uses reinforcement learning to detect anomalies or otherwise assess the operating conditions of the network. Accordingly, RL engine 412 may maintain and/or use any number of communication models 410 that model, e.g., various flows of traffic in the network. In further embodiments, DLC 408 may use any other form of machine learning techniques, such as those described previously (e.g., supervised or unsupervised techniques, etc.). For example, in the context of SLN for security, DLC 408 may perform modeling of traffic and applications in the area of the network associated with DLA 400. DLC 408 can then use the resulting models 410 to detect graph-based and other forms of anomalies (e.g., by comparing the models with current network characteristics, such as traffic patterns. The SCA may also send updates 414 to DLC 408 to update model(s) 410 and/or RL engine 412 (e.g., based on information from other deployed DLAs, input from a user, etc.).

When present, RL engine 412 may enable a feed-back loop between the system and the end user, to automatically adapt the system decisions to the expectations of the user and raise anomalies that are of interest to the user (e.g., as received via a user interface of the SCA). In one embodiment, RL engine 412 may receive a signal from the user in the form of a numerical reward that represents for example the level of interest of the user related to a previously raised event. Consequently the agent may adapt its actions (e.g. search for new anomalies), to maximize its reward over time, thus adapting the system to the expectations of the user. More specifically, the user may optionally provide feedback thanks to a lightweight mechanism (e.g., ‘like’ or ‘dislike’) via the user interface.

In some cases, DLA 400 may include a threat intelligence processor (TIP) 404 that processes anomaly characteristics so as to further assess the relevancy of the anomaly (e.g. the applications involved in the anomaly, location, scores/degree of anomaly for a given model, nature of the flows, or the like). TIP 404 may also generate or otherwise leverage a machine learning-based model that computes a relevance index. Such a model may be used across the network to select/prioritize anomalies according to the relevancies.

DLA 400 may also execute a Predictive Control Module (PCM) 406 that triggers relevant actions in light of the events detected by DLC 408. In order words, PCM 406 is the decision maker, subject to policy. For example, PCM 406 may employ rules that control when DLA 400 is to send information to the SCA (e.g., alerts, predictions, recommended actions, trending data, etc.) and/or modify a network behavior itself. For example, PCM 406 may determine that a particular traffic flow should be blocked (e.g., based on the assessment of the flow by TIP 404 and DLC 408) and an alert sent to the SCA.

Network Control Component (NCC) 418 is a module configured to trigger any of the actions determined by PCM 406 in the network nodes associated with DLA 400. In various embodiments, NCC 418 may communicate the corresponding instructions 422 to the network nodes using APIs 420 (e.g., DQoS interfaces, ABR interfaces, DCAC interfaces, etc.). For example, NCC 418 may send mitigation instructions 422 to one or more nodes that instruct the receives to reroute certain anomalous traffic, perform traffic shaping, drop or otherwise “black hole” the traffic, or take other mitigation steps. In some embodiments, NCC 418 may also be configured to cause redirection of the traffic to a “honeypot” device for forensic analysis. Such actions may be user-controlled, in some cases, through the use of policy maps and other configurations. Note that NCC 418 may be accessible via a very flexible interface allowing a coordinated set of sophisticated actions. In further embodiments, API(s) 420 of NCC 418 may also gather/receive certain network data 424 from the deployed nodes such as Cisco™ OnePK information or the like.

The various components of DLA 400 may be executed within a container, in some embodiments, that receives the various data records and other information directly from the host router or other networking device. Doing so prevents these records from consuming additional bandwidth in the external network. This is a major advantage of such a distributed system over centralized approaches that require sending large amount of traffic records. Furthermore, the above mechanisms afford DLA 400 additional insight into other information such as control plane packet and local network states that are only available on premise. Note also that the components shown in FIG. 4 may have a low footprint, both in terms of memory and CPU. More specifically, DLA 400 may use lightweight techniques to compute features, identify and classify observation data, and perform other functions locally without significantly impacting the functions of the host router or other networking device.

As noted above, IBA provides mechanisms useful for anomaly detection. Hypertext Transfer Protocol (HTTP) universal resource locator (URL) information presents one potential source of information for an anomaly detection system. HTTP URLs represent one potential source of information for an anomaly detection system. Reputation-based mechanisms, such as the Web based Reputation System (WBRS) and IronPort Store by Cisco Systems, Inc., update and maintain large databases of URLs that have been flagged as having malicious content.

A DLA, such as DLA 400, may leverage any number of techniques to identify HTTP URLs from network traffic. For example, NSC 416 of DLA 400, or another device in communication therewith, may perform DPI on traffic packets or employ NBAR or a similar mechanism, to extract URL information from the traffic. However, once the URL has been extracted at the edge of the network, comparing it against a reputation based database faces several technical limitations that will be discussed in the following. Note that the objective of retrieving reputation values for a URL in an SLN or other behavioral analytics architecture can be twofold: 1.) enrich context with additional threat intelligence feeds for raised anomalies, and 2.) influence machine learning based processes in search spaces (e.g. with unsupervised learning).

In some cases, DLA 400 or another networking device can export captured URL information to a central location (e.g., an SCA) by using protocols like IPFIX, which supports the export of variable length fields. However, this suffers of some scalability issues in terms of bandwidth consumption in the network (e.g., the WAN). In fact, since HTTP-based applications constitute a large portion of the monitored traffic, exporting the HTTP URL information would cause a non-negligible increase of the exported information rate and potentially congesting WAN links across the network.

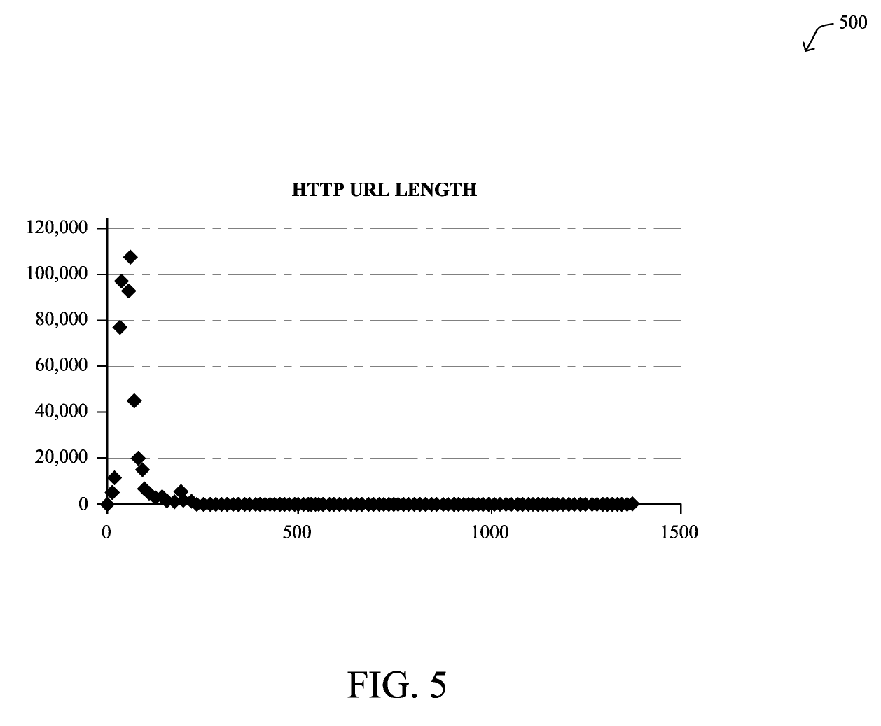

FIG. 5 shows an empirical distribution plot 500 of the length of extracted URLs collected on a branch office link during testing. As shown, plot 500 demonstrates that that, in most of the cases, the length of an exported URL is in the order of 100 bytes. Since a typical report for one flow (e.g., containing information about IPs, ports, number of octets, etc. of the flow) is typically only a few dozens of bytes, adding the HTTP URLs to such a report would thus create a non-negligible overhead.

Another approach entails importing a full reputation based database on each edge node/DLA of the network. Unfortunately, this approach is hardly scalable, as well. Notably, these types of nodes usually lack the resources to store a large reputation system. In addition, maintaining reputation databases at the edge devices would require the system to continuously update the databases across a large set of edge nodes, greatly increasing the overhead on the network.

Use of URL Reputation Scores in Distributed Behavioral Analytics Systems

The techniques herein introduce a mechanism that leverages the information of an HTTP URL reputation database in a system that includes a plurality of edge nodes/DLAs hosting anomaly detectors. Such nodes, in response to detecting an anomaly (e.g., determining that traffic in the network is anomalous), may send the HTTP URL(s) of the anomalous flows to the SCA. In turn, the SCA can reference the flows against a reputation database and potentially present the results to a user as part of the anomaly context. In some aspects, the system may allow a user to install anomaly filtering rules based on the reported URLs to one or more of the edge nodes, to increase or decrease the priority of anomalies involving the same URLs or the domains of the URLs. Particularly, using distributed tasks allows a central entity that receives a large amount of URL indicators of compromise (IOCs) to determine how to efficiently send a compressed signal (positive or negative) to remote edge devices. The edge devices may then dynamically adapt their scoring systems, to tune the scoring of anomalies and possibly impact their anomaly detecting processes.

Specifically, according to one or more embodiments of the disclosure as described in detail below, a device in a network identifies a universal resource locator (URL) from traffic destined for the URL that triggered a first anomaly detected by an anomaly detector. The device reports the first anomaly and the identified URL to a supervisory device in the network. The device receives a URL filter rule for the URL. The URL filter rule is configured to affect anomaly scores generated by the anomaly detector for traffic destined for the URL or a domain associated with the URL. The device uses the URL filter rule to adjust an anomaly score for a second anomaly detected by the anomaly detector based on the second anomaly involving traffic destined for the URL or the domain associated with the URL.

Illustratively, the techniques described herein may be performed by hardware, software, and/or firmware, such as in accordance with the SLN process 248, which may include computer executable instructions executed by the processor 220 (or independent processor of interfaces 210) to perform functions relating to the techniques described herein, e.g., in conjunction with routing process 244.

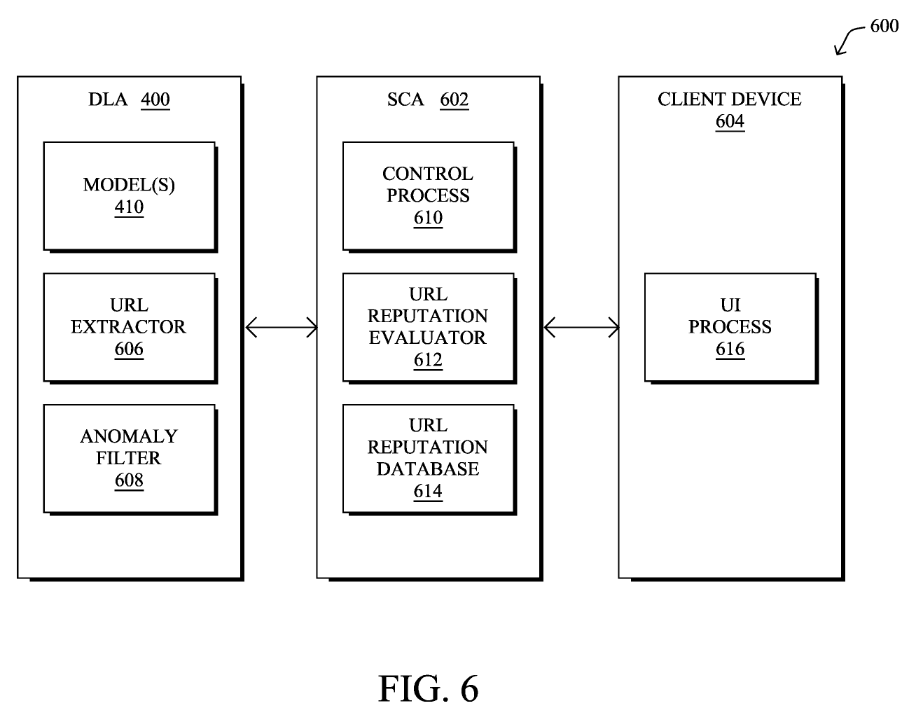

Operationally, an SLN architecture may implement the techniques herein. For example, FIG. 6 illustrates an example architecture 600 for using URL reputation scores in an SLN. As shown, architecture 600 may include a DLA 400, an SCA 602, and potentially a client device 604 in communication therewith.

As described above, SCA 602 may execute a control process 610 that provides supervisory control over DLA 400 and receives notifications of any anomalies detected by DLA 400. For example, control process 610 may receive administrative commands and/or parameters from a user interface (UI) process 616 executed by client device 604 or directly on SCA 602. Notably, control process 610 may generate visualizations for display by UI process 612, thereby allowing an administrator or other user to review the anomaly detection mechanisms in the network. In response, the user may provide feedback regarding any detected anomalies to DLA 400 via control process 610.

Also as described above, DLA 400 may generate and use any number of behavioral analytics models 410, to detect anomalous conditions in the network. These models may be based on any number of sets of sample data regarding the operation of the network (e.g., characteristics of the traffic flows in the network, metrics derived therefrom, etc.). For example, a statistical model may evaluate the probability of an observed event occurring in the network, given a set of prior observations regarding the network. If the probability of the observed event occurring is below a threshold, DLA 400 may determine that an anomaly has occurred. As would be appreciated, models 410 may comprise any number of different types of behavioral models, in further embodiments.

In various embodiments, SCA 602 may also execute a URL reputation evaluator 612 that is configured to determine a measure of the suspiciousness of a given URL. For example, reputation evaluator 612 may perform a lookup of a URL of interest in a URL reputation database 614, which may be stored locally on SCA 602 or on another device in communication with SCA 602. For example, reputation database 614 may include information regarding whether the particular URL has been reported as being associated with malware or other security threats. In some embodiments, URL reputation database 614 may also maintain information that can be used to quantify the suspiciousness of URLs at the domain level. For example, if an entry does not exist for a particular URL in reputation database 614, reputation evaluator 612 may still determine a reputation for the URL based on other entries in database 614 for URLs associated with the same domain.

In particular, SLN architecture 600 can consume the Netflow, IPfix, etc. data produced at the edge of the network on DLA 400 itself, thus preventing the need to export large amounts of monitoring data to a centralized server, such as SCA 602. For example, as shown, DLA 400 may include a URL extractor 606 configured to identify any URL(s) associated with traffic deemed anomalous using model(s) 410. URL extractor 606 may be, for example, a component of NSC 416 or a stand-alone process that conjunction therewith, in various cases. In further embodiments, DLA 400 may also include an anomaly filter process 608 configured to apply any number of URL filter rules to traffic deemed anomalous by DLA 400 based on the identified URL(s) associated with the anomalous traffic.

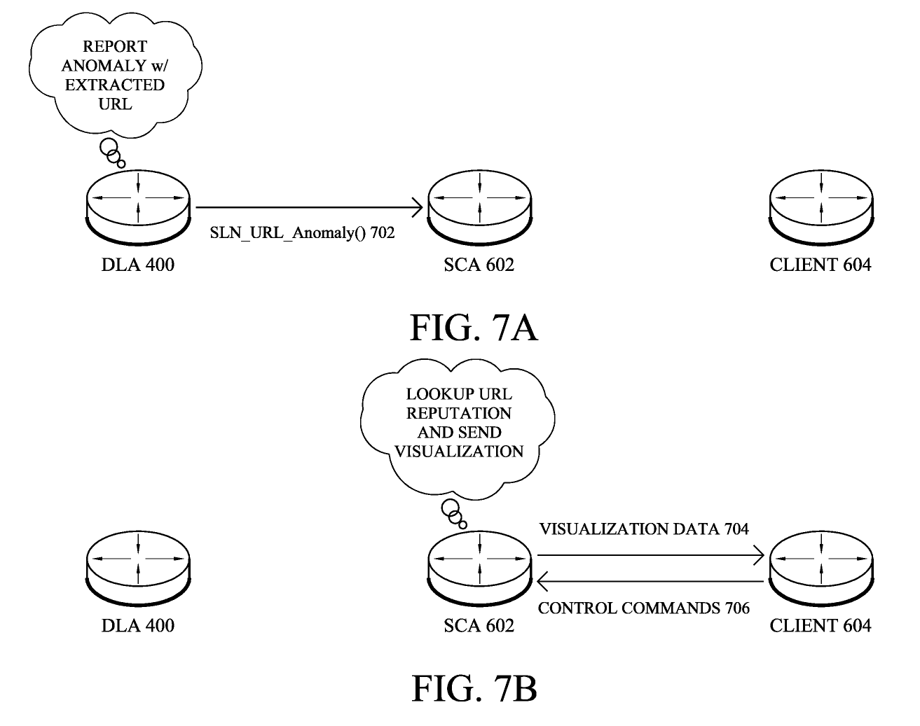

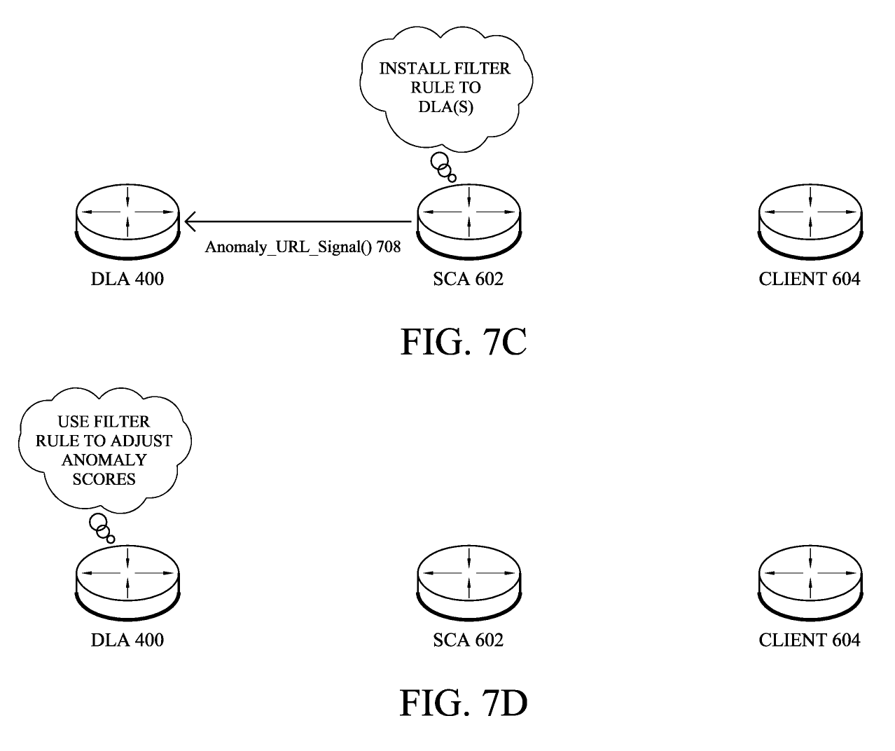

FIGS. 7A-7D illustrate examples of DLA 400 using a URL filter based on a reputation score, according to various embodiments. As shown in FIG. 7A, assume that DLA 400 analyzes a set of HTTP traffic in the network and, based on the analysis, determines that the traffic is somehow anomalous. For example, if outgoing HTTP traffic from the local network is typically nonexistent or at a minimum at 2:00 AM, and there is a sudden spike in HTTP traffic at this time, DLA 400 may flag the traffic as anomalous. In such cases, DLA 400 may also extract/identify any URLs associated with the anomalous traffic (e.g., using URL extractor 606) locally. By performing the URL analysis locally on DLA 400, this does not increase the bandwidth overhead in the network. In some embodiments, DLA 400 may only export flow-granularity information, such as URL information, to SCA 602 unless DLA 400 determines that the corresponding traffic is anomalous.

In particular, the HTTP URL(s) of anomalous HTTP traffic can be extracted on the network element (e.g., the router/switch, etc.) by leveraging one among several possible mechanisms such as, e.g., any or all of the following:
NBAR2 DPI engine which exports sub-application data through IPFIX.
Direct DPI analysis of relevant packets. Notably, the SLN architecture may support the capturing of a subset of the traffic and providing DPI-derived data to the DLA thanks to a local programmatic interface (e.g. ERSPAN, etc.).

Once DLA 400 detects an anomaly, it may send a custom SLN_URL_ANOMALY( ) message 702 to SCA 602 that includes contextual information regarding the detected anomaly (e.g., the IP of the flows involved in the anomaly, byte counts, etc.). In addition, the technique herein also propose DLA 400 exporting the identified URL(s) associated with the anomalous traffic to SCA 602, such as via message 702. Since the anomalous flows are typically only a tiny subset of all of the flows monitored by the DLAs in the network, the bandwidth impact of such a mechanism is negligible. In some cases, DLA 400 may also use any number of compression techniques, to reduce the size of messages 702 to SCA 602. For example, DLA 400 may only export the differences among the anomalous URLs to SCA 602, to help conserve network bandwidth. Notably, it is likely that anomalous flows will try to access the same resource repeatedly.

As shown in FIG. 7B, the techniques herein also introduce a component co-located with SCA 602 (e.g., reputation evaluator 612) that compares the URLs included in the exported anomaly context of message 702 to the local URL reputation database 614 of SCA 602. In some cases, SCA 602 may use the resulting reputation information to enrich the corresponding anomaly report for presentation to the user. For example, SCA 602 may send visualization data 704 to client device 604, to alert the user as to the detected anomaly and provide contextual information regarding the anomaly. Visualization data 704 may include, e.g., a list of URL(s) associated with the anomalous traffic, a measure of their suspiciousness/maliciousness based on the query to reputation database 614, and any other information that the user can assess to take corrective measures. For example, after evaluating the reported anomaly, the user of client device 604 may operate UI process 616 to send control commands 706 back to SCA 602, to control how the SLN should handle the anomaly.

In various embodiments, SCA 602 may use the results of its URL reputation lookup, to propose the installation of a local anomaly filter on DLA 400 via visualization data 704. More specifically, if the lookup established any of the exported URLs to be associated with a potentially malicious domain (e.g., a positive signal), SCA 602 may suggest to the user that a filter rule should be installed on DLA 400 which will increase the anomaly score of candidate anomalies associated with the detected URLs and/or domain.

Conversely, if the lookup on reputation database 614 showed that the involved URL/domain is benign (e.g., a negative signal, meaning that the raised anomaly is likely to be a false positive), SCA 602 may instead suggest the installation of a filter rule onto DLA 400 to deprioritize the candidate anomalies associated with such a URL or domain. Such a filter rule may act as a URL white list and can be installed on one or more DLAs (similarly to the case of a positive filter) and/or locally on SCA 602.

Negative signals can be used for two purposes. First, SCA 602 may use a generated URL filter rule to hide filtered anomalies from the user of client device 604 (e.g., by excluding the anomaly and context information from visualization data 704). Although not reported, SCA 602 may still log and store this information for a-posteriori analysis, in some embodiments. Second, DLA 400 may use a generated URL filter rule to drop negative anomalies before reporting them to SCA 602, thus saving WAN consumption bandwidth. In various embodiments, SCA 602 can suggest to the user to install such a rule only on the DLA that detected the anomaly (e.g., via visualization data 704), on all of the DLAs managed by SCA 602, or just on a subset of them (e.g., all of the branch offices for a particular reason or all of the branch offices hosting servers for a particular application). In further embodiments, SCA 602 may proactively generate and send a URL filter rule to DLA 400, without first receiving feedback from the user of client device 604 or if user feedback is not received within a certain amount of time.

As shown in FIG. 7C, SCA 602 may send the generated URL filter rule to DLA 400 and/or any other DLAs using a custom Anomaly_URL_Signal( ) message 708. In turn, DLA 400 may install the rule for future analysis of traffic flows involving the URL or domain associated with the URL, according to the rule.

In response to receiving a URL filter rule, as shown in FIG. 7D, DLA 400 may use the filter rule to adjust the anomaly scores of anomalies that involve the URL(s) or domain(s) defined in the rule. Notably, DLA 400 and SCA 602 may implement a policy to rank positive signals according to a degree of severity tied to the IOC for the URL or domain. For example, if SCA 602 flags a particular URL as highly suspicious and the URL has been observed in a number of reported anomalies, SCA 602 may preventatively send Anomaly_URL_Signal( ) messages 708 to the remote DLAs in the network, so they can take appropriate actions.

In particular, anomaly filter process 608 on DLA 400 may implement a closed loop control strategy that is plugged into the local anomaly ranking logic which makes the decision about raising an anomaly (e.g., DLC 408). Such a component stores the HTTP URL rules sent by SCA 602 via messages 708 and uses them to influence the ranking of the candidate anomalies. As would be appreciated, the URLs/domains included in the filter rules installed on DLA 400 will be a much smaller subset of reputation database 614 hosted by SCA 602. For example, DLA 400 may only need to maintain URL or domain information for URLs/domains associated with previously raised anomalies in the SLN and/or for which the user has requested a filter rule. This allows leveraging the effectiveness of reputation based rules without the need of keeping a large database on each edge node.

In some embodiments, a URL filter rule may also have an associated expiration lifespan. For example, message 708 may also indicate that a given filter rule is only to remain active for the next n-number of hours, days, months, etc. On expiration of one of the rules, DLA 400 can either purge it silently or notify SCA 602. In turn SCA 602 may notify the user of client device 604 that the rule has expired, allowing the user to control whether or not the rule should be reactivated.

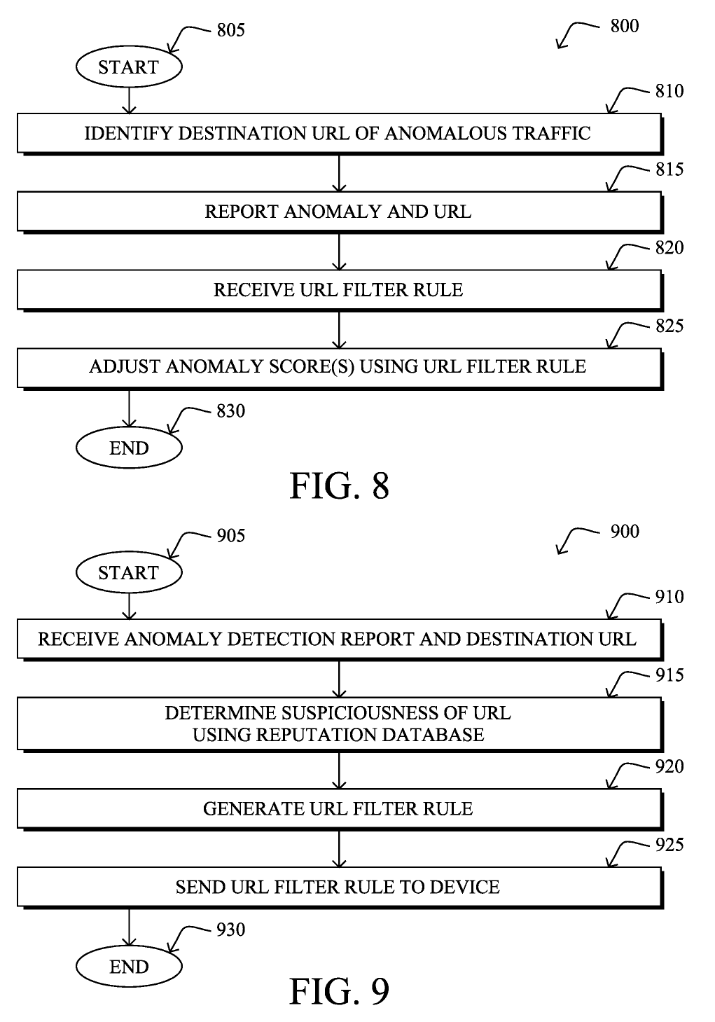

FIG. 8 illustrates an example simplified procedure for using a URL filter rule, in accordance with the various embodiments herein. In general, a specialized networking device, such as an edge router, may perform procedure 800, to assess whether traffic or other conditions in the network are anomalous. Procedure 800 starts at step 805 and continues on to step 810 where, as described in greater detail above, the device may identify the destination URL(s) of any network traffic deemed anomalous by an anomaly detector. For example, if a behavioral model of the device determines that a particular traffic flow is anomalous, the device may also identify any URLs and/or domains associated with the traffic. The device may leverage various techniques to identify the URL information such as, but not limited to, DPI of the traffic packets themselves or leveraging NBAR or a similar traffic analysis mechanism.

At step 815, as detailed above, the device may report the detected anomaly and the corresponding URL(s) to a supervisory device, such as an SCA. The anomaly report may include various contextual information regarding the anomalous traffic such as, e.g., the addresses or ports associated with the traffic, an application or protocol associated with the traffic, the URLs associated with the traffic, etc. In turn, the supervisory device may use the URL to perform a lookup of the reputation of the reported URL. In various embodiments, the anomaly report may also include a plurality of URLs associated with traffic, some of which may be benign while others are suspicious or malicious.

At step 820, the device may receive a URL filter rule from the supervisory device, in response to reporting the detected anomaly, as described in greater detail above. In general, the filter rule may cause the device to adjust how the device treats subsequent anomalies involving the URL and/or other URLs associated with the same domain. For example, if the URL was deemed benign, the filter rule may be configured to deprioritize the anomaly scores of future anomalies involving the URL. Conversely, if the URL was deemed suspicious, the filter rule may cause the device to increase the reporting rank of the subsequent anomalies involving the URL and/or domain. In some embodiments, an administrative user may provide feedback regarding the rule, to initiate installation of the rule onto the networking device. For example, if the reported URLs include both benign and suspicious URLs, the filter rule may be applied across the board to both types, based on feedback from a user.

At step 825, as detailed above, the device may adjust the anomaly score of a second anomaly involving the URL or corresponding domain, based on the received URL filtering rule. Notably, the device may suppress anomalies involving URLs deemed benign or, conversely, increase the reporting priority of anomalies involving URLs or domains deemed suspicious/malicious. In some cases, the filter rule may also have an associated lifespan that, upon expiration, causes the device to stop using the rule for purposes of anomaly filtering. Procedure 800 then ends at step 830.

FIG. 9 illustrates an example simplified procedure for generating and sending a URL filter rule, in accordance with the various embodiments herein. Generally, a supervisory device such as an SCA may perform procedure 900, to provide supervisory control over one or more DLAs/networking devices in the network. Procedure 900 starts at step 905 and continues on to step 910 where, as described in greater detail above, the supervisory device receives an anomaly detection report from the networking device and one or more URLs associated with the detected anomaly.

At step 915, as detailed above, the supervisory device may determine a measure for the suspiciousness of the URL. For example, the supervisory device may perform a lookup of the URL using one or more local or remote reputation databases. Such databases may maintain reputation scores indicative of the suspiciousness (e.g., maliciousness) of a URL and/or domain based on previous reports of malware, data exfiltration, or other security incidents involving the destination.

At step 920, the supervisory device may generate a URL filter rule for the URL and/or domain, as described in greater detail above. For example, if the measure of suspiciousness of the URL indicates that the URL is benign, the device may generate a URL filter rule that causes a DLA to suppress or otherwise deemphasize further anomalies involving the URL. Conversely, if the measure of suspiciousness indicates that the URL is suspicious or even malicious, the rule may cause the DLA to increase a reporting rank of subsequent anomalies that involve the URL or domain associated with the URL. In further embodiments, the supervisory device may generate the URL filter rule based in part on feedback from a user interface device (e.g., in response to a filter request from an administrator, etc.).

The reported anomaly may also include a plurality of URLs, each of which may or may not be suspicious on its own. In further embodiments, the URL filter rule may be based on an aggregated measure of suspiciousness of the plurality of URLs or a subset of the reported plurality. In addition, the URL filter rule may apply to a specific URL included in the reported plurality, a domain associated with the specific URL, a subset of the URLs and/or domains associated with the subset, the entire set of reported URLs and/or associated domains. In further embodiments, the filter rule may also apply to additional URLs and/or domains not included in the anomaly detection report. For example, if a particular reported URL is associated with a certain type of malware or other network anomaly, the generated filter rule may apply to both the particular URL as well as any additional URLs and/or domains associated with the type of malware or other threat.

At step 925, as detailed above, the supervisory device may send the generated URL filter rule to the networking device that reported the anomaly. In doing so, the supervisory device can affect how the networking device/DLA will handle future anomalies involving the URL and/or domain indicated in the rule. In further embodiments, the supervisory device may also install the rule onto one or more other devices/DLAs in the network, as well. Procedure 900 then ends at step 930.

It should be noted that while certain steps within procedures 800-900 may be optional as described above, the steps shown in FIGS. 8-9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 800-900 are described separately, certain steps from each procedure may be incorporated into each other procedure, and the procedures are not meant to be mutually exclusive.

The techniques described herein, therefore, leverage one or more large databases of URL reputation scores that cannot be distributed on a large number of remote systems, such as deployed learning agents. When forwarding anomalies, the techniques herein may reduce false positives on centralized systems. The techniques herein may also improve the scoring of anomalies on remote systems, improve bandwidth consumption by discarding anomalies at the edge, if related to anomalies for URLs that are not suspicious. In further aspects, the techniques herein present a feedback loop that can adapt the search for anomalies related to suspicious URLs. Notably, the techniques allow edge devices to leverage the knowledge in a reputation based database stored in a centralized location without requiring the export of the information for each monitored flow or requiring each monitoring node to maintain the database locally.

While there have been shown and described illustrative embodiments that provide for the use of URL reputation scores in distributed behavioral analytics systems, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, such as BGP, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
extracting, by a device in a network, a universal resource locator (URL) from traffic destined for the URL that triggered a first anomaly detected by an anomaly detector;
reporting, by the device, the first anomaly and the extracted URL to a supervisory device in the network, wherein the supervisory device compares the URL to a URL reputation database stored on the supervisory device and uses results from the comparison to generate a URL filter rule for the URL;
receiving, at the device, the URL filter rule for the URL from the supervisory device, wherein the URL filter rule is configured to affect anomaly scores generated by the anomaly detector for traffic destined for the URL or a domain associated with the URL; and
dynamically adjusting, by the device and using the URL filter rule from the supervisory device, an anomaly score when a second anomaly is detected by the anomaly detector that is associated with traffic destined for the URL or the domain associated with the URL.

2. The method as in claim 1, wherein the device is a network edge router.

3. The method as in claim 1, wherein the traffic destined for the URL that triggered the first anomaly is Hypertext Transfer Protocol (HTTP) traffic.

4. The method as in claim 1, wherein the supervisory device uses the URL reputation database to determine that the URL is benign, and wherein adjusting the anomaly score using the URL filter rule comprises:
deprioritizing the anomaly score for the second anomaly using the URL filter rule, to suppress reporting of the second anomaly to the supervisory device.

5. The method as in claim 1, wherein the supervisory device uses the URL reputation database to determine that the URL is suspicious, and wherein adjusting the anomaly score using the URL filter rule comprises:
increasing a reporting rank of the second anomaly for purposes of reporting the second anomaly to the supervisory device.

6. The method as in claim 1, wherein the received URL filter rule is associated with a lifespan, the method further comprising:
disabling, by the device, the URL filter rule after expiration of the associated lifespan.

7. The method as in claim 1, wherein the URL filter rule is received at the device in response to feedback from a user interface regarding the reported first anomaly.

8. The method as in claim 1, further comprising:
detecting, by the device, the first anomaly by analyzing the traffic destined for the URL using a behavioral model, wherein the first anomaly is reported based in part on an anomaly score generated by the behavioral model for the first anomaly.

9. The method as in claim 1, wherein identifying the URL comprises:
performing deep packet inspection on the traffic that triggered the first anomaly.

10. A method, comprising:
receiving, at a supervisory device in a network, an anomaly report that indicates that another device in the network detected anomalous traffic, wherein the anomaly report comprises a universal resource locator (URL) to which the anomaly traffic was destined that was extracted by the another device;
determining, by the supervisory device, a measure of suspiciousness of the URL using a reputation database;
generating, by the supervisory device, a URL filter rule based on the measure of suspiciousness, wherein the URL filter rule is configured to affect anomaly scores generated by an anomaly detector for traffic destined for the URL or a domain associated with the URL; and
sending, by the supervisory device, the URL filter rule to the device that detected the anomalous traffic, wherein the device that detected the anomalous traffic dynamically adjusts an anomaly score for a subsequent anomaly using the URL filter rule.

11. The method as in claim 10, wherein the URL filter rule is generated in response to feedback regarding the anomaly report from a user interface.

12. The method as in claim 10, wherein the measure of suspiciousness indicates that the anomaly report is a false positive, and wherein the URL filter rule is configured to suppress further anomalies associated with the URL or the domain.

13. The method as in claim 10, wherein the measure of suspiciousness indicates that the anomaly report is a true positive, and wherein the URL filter rule is configured to increase a reporting rank of a further anomaly associated with the URL or the domain.

14. An apparatus, comprising:
one or more network interfaces to communicate with a network;
a processor coupled to the network interfaces and configured to execute one or more processes; and
a memory configured to store a process executable by the processor, the process when executed operable to:
extract a universal resource locator (URL) from traffic destined for the URL that triggered a first anomaly detected by an anomaly detector;
report the first anomaly and the extracted URL to a supervisory device in the network, wherein the supervisory device compares the URL to a URL reputation database stored on the supervisory device and uses results from the comparison to generate a URL filter rule for the URL;
receive a URL filter rule for the URL from the supervisory device, wherein the URL filter rule is configured to affect anomaly scores generated by the anomaly detector for traffic destined for the URL or a domain associated with the URL; and
dynamically adjust, using the URL filter rule from the supervisory device, an anomaly score when a second anomaly is detected by the anomaly detector that is associated with traffic destined for the URL or the domain associated with the URL.

15. The apparatus as in claim 14, wherein the supervisory device uses the URL reputation database to determine that the URL is benign, and wherein the apparatus adjusts the anomaly score using the URL filter rule by:
deprioritizing the anomaly score for the second anomaly using the URL filter rule, to suppress reporting of the second anomaly to the supervisory device.

16. The apparatus as in claim 14, wherein the supervisory device uses the URL reputation database to determine that the URL is suspicious, and wherein the apparatus adjusts the anomaly score using the URL filter rule by:
increasing a reporting rank of the second anomaly for purposes of reporting the second anomaly to the supervisory device.

17. The apparatus as in claim 14, wherein the received URL filter rule is associated with a lifespan, and wherein the apparatus is configured to disable the URL filter rule after expiration of the associated lifespan.

18. The apparatus as in claim 14, wherein the URL is identified by performing deep packet inspection on the traffic that triggered the first anomaly.

19. The apparatus as in claim 14, wherein the apparatus comprises an edge router, and wherein the traffic destined for the URL that triggered the first anomaly is Hypertext Transfer Protocol (HTTP) traffic.

20. The apparatus as in claim 14, wherein the process when executed is further operable to:
detect the first anomaly by analyzing the traffic destined for the URL using a behavioral model, wherein the first anomaly is reported based in part on an anomaly score generated by the behavioral model for the first anomaly.
